(19) United States
(12) Patent Application Publication
(10) Pub. No.: US 2007/0123292 A1
(43) Pub. Date: May 31, 2007

(54) Method and system for acquiring information about neighbor base stations and neighbor relay stations in a multi-hop relay broadband wireless access communication system

(75) Inventors: Hyun-Jeong Kang, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Anyang-si (KR); Sung-Jin Lee, Seoul (KR); Mi-Hyun Lee, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/520,156

(22) Filed: Sep. 13, 2006

(30) Foreign Application Priority Data
Sep. 13, 2005 (KR) 10-2005-0085421

(51) Int. Cl. H04B 7/00; H04Q 7/20

(52) U.S. Cl. 455/525

(57) ABSTRACT

A method and system for acquiring information about neighbor base stations (BSs) and neighbor relay stations (RSs) in a multi-hop relay broadband wireless access communication system are provided. In the method, a serving BS collects information about the neighbor BSs and the neighbor RSs, generates a message including the collected information, and transmits the message to a serving RS and an MSS directly communicating with the serving BS. The serving RS transmits the message to an MSS communicating with the serving BS via the serving RS.

### PRIORITY

This application claims priority under 35 U.S.C. § 119 to an application entitled “Method and System for Acquiring Information about Neighbor Base Stations and Neighbor Relay Stations in a Multi-Hop Relay Broadband Wireless Access Communication System” filed in the Korean Intellectual Property Office on Sep. 13, 2005 and assigned Serial No. 2005-85421, the contents of which are incorporated herein by reference.

### BACKGROUND OF THE INVENTION

1. Field of the Invention

The present invention relates generally to a multi-hop relay Broadband Wireless Access (BWA) communication system and, in particular, to a method and system for acquiring information about neighbor Base Stations (BSs) and neighbor Relay Stations (RSs) in a Mobile Subscriber Station (MSS).

2. Description of the Related Art

In the future-generation 4^{th} Generation (4G) communication system, extensive research is being provided into services with diverse Quality of Service (QoS) levels at about 100 Mbps. Particularly, active research being is conducted into providing high-speed service by ensuring mobility and QoS to a BWA communication system such as Wireless Local Area Network (WLAN) and Wireless Metropolitan Area Network (WMAN). Examples of such research are Institute of Electrical and Electronics Engineers (IEEE) 802.16a and IEEE 802.16e.

The IEEE 802.16a and IEEE 802.16e communication systems are implemented by applying Orthogonal Frequency Division Multiplexing (OFDM)/Orthogonal Frequency Division Multiple Access (OFDMA) to physical channels of the WMAN system. IEEE 802.16a considers only a single-cell structure with no regard to mobility of SSs. In contrast, IEEE 802.16e supports the SS' mobility to the IEEE 802.16a communication system. A mobile SS is called an MSS.

FIG. 1 illustrates the configuration of the conventional IEEE 802.16e communication system, configured in a multi-cell structure. Specifically, the system includes cells 100 and 150, BSs 110 and 140 for managing the cells 100 and 150, respectively, and a plurality of MSSs 111, 113, 130, 151 and 153. Signals are sent and received between BSs 110 and 140 and MSSs 111, 113, 130, 151 and 153 in OFDM/OFDMA. The MSS 130 exists in a cell boundary area between cells 100 and 150, i.e. in a handover region. When MSS 130 moves to cell 150 managed by BS 140 during signal transmission/reception to/from BS 110, the serving BS of MSS 130 changes from BS 110 to BS 140.

In the conventional IEEE 802.16e communication system as illustrated in FIG. 1, signaling transmission/reception is performed between a fixed BS and an MSS via a direct link, such that a highly reliable radio communication link can be easily established between them. Yet, due to the fixed position of the BS, a radio network cannot be flexibly configured. As a result, it is difficult to provide an efficient communication service in a radio environment with a fluctuating traffic distribution or a substantial change in the number of calls required.

To overcome the above shortcoming, a multi-hop relay data transmission scheme can be implemented through fixed or mobile RSs or general MSSs in a typical cellular wireless communication system such as the IEEE 802.16e communication system. The multi-hop relay wireless communication system adaptively reconfigures a network according to a communication environment change and efficiently operates the entire wireless network. It also extends a cell service area and increases system capacity. When there is poor channel status between a BS and an MSS, an RS is installed between them\, thus establishing a multi-hop relay path through the RS, so that a good radio channel can be provided to the MSS. Also, with the use of the multi-hop relay in a cell boundary area with a poor channel state, a high-speed data channel can be provided and the cell service area can be expanded.

FIG. 2 illustrates the configuration of a multi-hop relay BWA communication system.

Referring to FIG. 2, the multi-hop relay BWA communication system, which is configured in a multi-cell structure, includes cells 200 and 240, BSs 210 and 250 for managing the cells 200 and 240, respectively, a plurality of MSSs 211 and 213 within the coverage area of the cell 200, a plurality of MSSs 221 and 223 managed by the BS 210 but located outside the coverage area 230 of the cell 200, an RS 220 for providing a multi-hop relay path between the BS 210 and the MSSs 221 and 223 within the coverage area 230, a plurality of MSSs 251, 253 and 255 within the coverage area of the cell 240, a plurality of MSSs 261 and 263 managed by the BS 250 but outside the coverage area 270 of the cell 240, and an RS 260 for providing a multi-hop relay path between the BS 250 and the MSSs 261 and 263 within the coverage area 270. Signals are transmitted and received among the BSs 210 and 250, the RSs 220 and 260, and the MSSs 211, 213, 221, 223, 251, 253, 255, 261 and 263 in OFDM/OFDMA. Although the MSSs 211 and 213 within the coverage area of the cell 200, and the RS 220 can communicate directly with the BS 210, the MSSs 221 and 223 within the coverage area 230 cannot communicate with the BS 210, directly. Therefore, the RS 220 controlling the coverage area 230 relays signals between the BS 210 and the MSSs 221 and 223. Meanwhile, although the MSSs 251, 253 and 255 within the coverage area of the cell 240, and the RS 260 can communicate directly with the BS 250, the MSSs 261 and 263 within the coverage area 270 cannot directly communicate with the BS 250. Therefore, the RS 260 controlling the coverage area 270 relays signals between the BS 250 and the MSSs 261 and 263.

As the RSs 220 and 260 and the MSSs 211, 213, 221, 223, 251, 253, 255, 261 and 263 may have mobility, inter-cell handover or handover from inside to outside a cell can occur. Accordingly, a handover MSS and a handover RS need neighbor RS information, and the handover MSS needs neighbor BS information in the IEEE 802.16e communication system illustrated in FIG. 1.

### SUMMARY OF THE INVENTION

An object of the present invention is to substantially solve at least the above shortcomings and/or disadvantages and to provide at least the advantages below. Accordingly, an object of the present invention is to provide a method and system for providing information about neighbor BSs and neighbor RSs to an MSS and an RS that communicate directly with a BS in a multi-hop relay BWA communication system.

Another object of the present invention is to provide a method and system for providing information about neighbor BSs and neighbor RSs to a relay-mode MSS which cannot communicate directly with a BS by an RS in a multi-hop relay BWA communication system.

The above objects are achieved by providing a method and system for acquiring information about neighbor BSs and neighbor RSs in a multi-hop relay BWA communication system.

According to the present invention, in a first embodiment of a method of acquiring information about neighbor BSs and neighbor RSs in a multi-hop relay BWA communication system, a serving BS generates a message including the collected information, and transmits the message to a serving RS and an MSS directly communicating with the serving BS. The serving RS transmits the message to an MSS communicating with the serving BS via the serving RS.

According to the present invention, in a second embodiment of a method of acquiring information about neighbor BSs and neighbor RSs in a multi-hop relay BWA communication system, a serving BS collects information about the neighbor BSs and the neighbor RSs, generates a first message including information about the neighbor BSs and neighbor RSs managed by the neighbor BSs, and generates a second message including information about neighbor RSs managed by the serving BS. The serving BS checks transmission periods of the first and second messages and transmits the first and second messages to a serving RS and an MSS directly communicating with the serving BS in the transmission periods.

According to the present invention, in a third embodiment of a method of acquiring information about neighbor BSs and neighbor RSs in a multi-hop relay BWA communication system, a serving BS collects information about the neighbor BSs and the neighbor RSs, generates a first message including information about the neighbor BSs, and generates a second message including information about the neighbor RSs. The serving BS checks transmission periods of the first and second messages and transmits the first and second messages to a serving RS and an MSS directly communicating with the serving BS in the transmission periods. The serving RS transmits the first and second messages to an MSS communicating with the serving BS via the serving RS.

According to the present invention, in a fourth embodiment of a method of acquiring information about neighbor BSs and neighbor RSs in a multi-hop relay BWA communication system, a serving BS collects information about the neighbor BSs and the neighbor RSs, generates a first message including the collected information, and transmits the first message to a serving RS and an MSS directly communicating with the serving BS. The serving RS creates a list of neighbor BSs and neighbor RSs required for the MSS communicating with the serving BS via the serving RS, generates a second message including the list, and transmits the second message to an MSS communicating with the serving BS via the serving RS.

According to the present invention, in a first embodiment of a system for acquiring information about neighbor BSs and neighbor RSs in a multi-hop relay BWA communication system, a serving BS collects information about the neighbor BSs and the neighbor RSs, generating a first message including the collected information, and transmits the first message to a serving RS and an MSS directly communicating with a serving BS. The serving RS acquires the information about the neighbor BSs and the neighbor RSs, creates a list of neighbor BSs and neighbor RSs required for an MSS communicating with the serving BS via the serving RS, generates a second message including the list, and transmits the second message to the MSS communicating with the serving BS via the serving RS.

According to the present invention, in a second embodiment of a system for providing information about neighbor BSs and neighbor RSs in a multi-hop relay BWA communication system, a serving BS collects information about the neighbor BSs and the neighbor RSs, generates a first message including information about neighbor BSs and neighbor RSs managed by the neighbor BSs and a second message including information about neighbor RSs managed by the serving BS, checks transmission periods of the first and second messages, and transmits the first and second messages to a serving RS and an MSS directly communicating with the serving BS in the transmission periods. Upon receipt of the first message, the serving RS transmits the first message to an MSS communicating with the serving BS via the serving RS, and upon receipt of the second message, it generates a third message including information about the serving BS and the neighbor RSs managed by the serving BS, and transmits the third message to the MSS communicating with the serving BS via the serving RS.

According to the present invention, in a third embodiment of a system for providing information about neighbor BSs and neighbor RSs in a multi-hop relay BWA communication system, a serving BS collects information about the neighbor BSs and the neighbor RSs, generates a first message including information about the neighbor BSs and a second message including information about the neighbor RSs, checks transmission periods of the first and second messages, and transmits the first and second messages to a serving RS and an MSS directly communicating with the serving BS in the transmission periods. Upon receipt of the first and second messages, the serving RS transmits the first and second messages to an MSS communicating with the serving BS via the serving RS.

According to the present invention, a serving BS collects information about the neighbor BSs and the neighbor RSs, generates a message containing the collected information, checks a transmission period of the message, and transmits the message to a serving RS and an MSS directly communicating with the serving BS in the transmission period. Upon receipt of the message, the serving RS transmits the message to an MSS communicating with the serving BS via the serving RS.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a conventional IEEE 802.16e communication system;

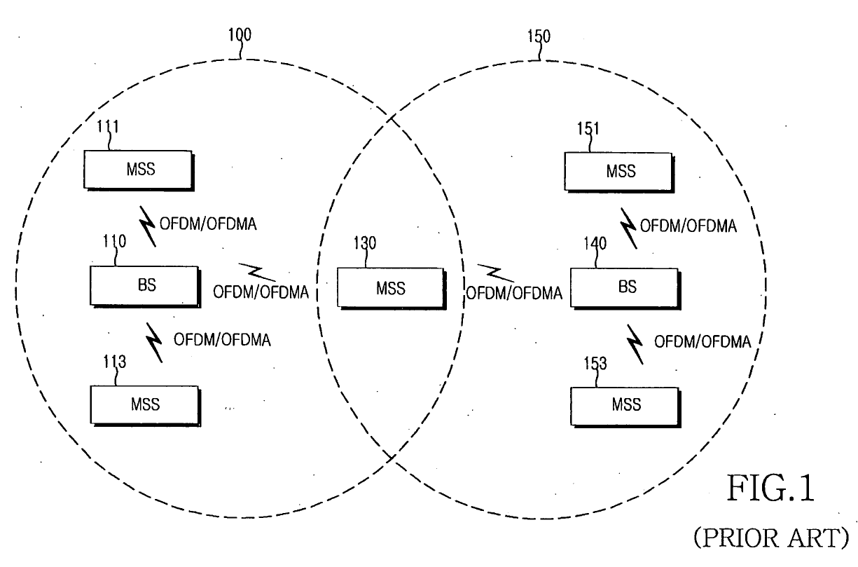

FIG. 2 illustrates the configuration of a conventional multi-hop relay BWA communication system;

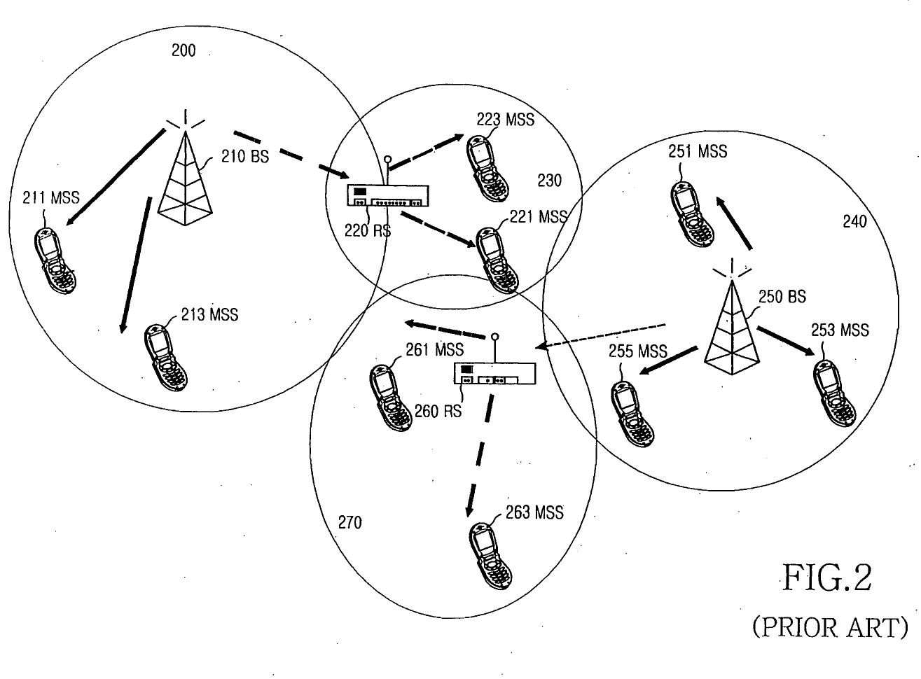

FIG. 3 is a diagram illustrating a signal flow for sending information about neighbor BSs and neighbor RSs configured by a serving BS in the multi-hop relay BWA communication system according to a first embodiment of the present invention;

FIG. 4 is a diagram illustrating a signal flow for sending information about neighbor BSs and neighbor RSs configured by the serving BS in the multi-hop relay BWA communication system according to a second embodiment of the present invention;

FIG. 5 is a diagram illustrating a signal flow for sending information about neighbor BSs and neighbor RSs configured by the serving BS in the multi-hop relay BWA communication system according to a third embodiment of the present invention;

FIG. 6 is a diagram illustrating a signal flow for sending information about neighbor BSs and neighbor RSs configured by the serving BS in the multi-hop relay BWA communication system according to a fourth embodiment of the present invention;

FIG. 7 is a block diagram of an MSS in the multi-hop relay BWA communication system according to the present invention; and

FIG. 8 is a block diagram of an RS or a BS in the multi-hop relay BWA communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention is intended to provide a method and system for acquiring information about neighbor BSs and neighbor RSs by an MSS in a multi-hop relay BWA communication system. The multi-hop relay BWA communication system operates in OFDM/OFDMA. Because of transmission of physical channel signals on multiple subcarriers, the multi-hop relay BWA communication system enables high-speed data transmission. The multi-hop relay BWA communication system also supports a multi-cell structure, thus supporting the mobility of the MSS. The RS is a fixed or mobile node, or it may include a particular system installed by the BS or a conventional subscriber station (SS0. Any node having the above feature can be chosen as an RS according to a pre-defined rule for expansion of cell area or cell capacity in the BS through a relay capabilities negotiation procedure with the BS.

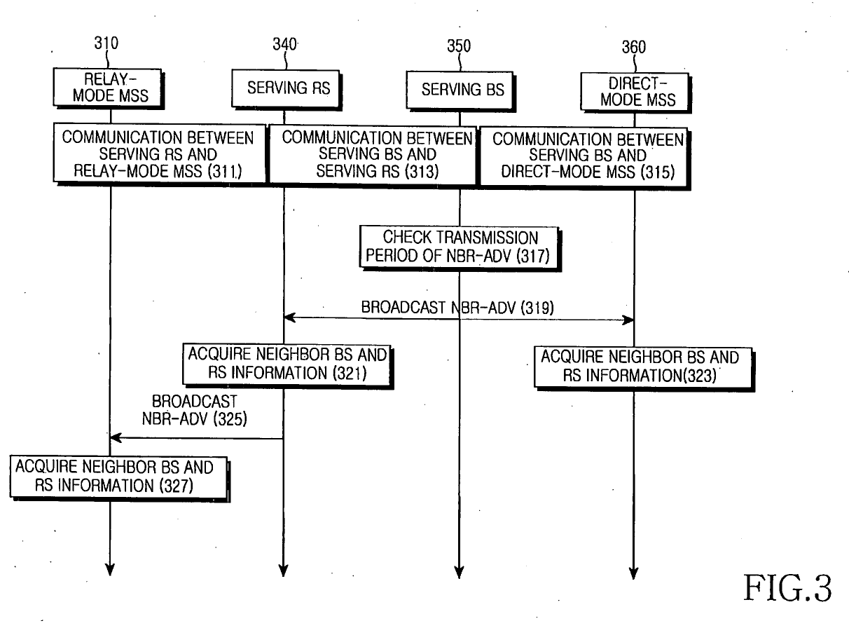

FIG. 3 is a diagram illustrating a signal flow for sending information about neighbor BSs and neighbor RSs configured by a serving BS in the multi-hop relay BWA communication system according to a first embodiment of the present invention.

Referring to FIG. 3, in relay mode, an MSS 310 communicates with a serving RS 340 in step 311 and the serving RS 340 communicates with a serving BS 350 in step 313. An MSS 360 communicates directly with the serving BS 350 in direct mode in step 315.

In step 317, the serving BS 350 collects information about neighbor BSs and neighbor RSs, and checks the transmission period of a neighbor BS/RS advertisement (NBR-ADV) message including the neighbor BS and RS information. The serving BS 350 then broadcasts the NBR-ADV message to the serving RS 340 and the direct-mode MSS 360 in step 319.

The NBR-ADV message has the following configuration illustrated in Table 1.

TABLE 1

| Syntax | Size (bits) | Notes |
|---|---|---|
| NBR-ADV_format( ){ | | |
| Management Message Type | 8 | To be determined |
| =TBD | | |
| N_BS | 8 | Number of BSs; the serving BS may be |
| | | included |
| for(i=0;i<N_BS;i++){ | | |
| BS ID | 48 | BS Identifier |
| BS preamble index | 8 | — |
| BS synchronization | variable | The BS information that is necessary for MSS |
| information | | or RS to acquire synchronization with this BS |
| N_RS | 8 | Number of relay stations |
| for(j=0;j<N_RS;j++){ | | |
| RS ID | 48 | RS Identifier |
| RS preamble index | 8 | — |
| RS synchronization | variable | The RS information that is necessary for MSS |
| information | | or other RS to acquire synchronization with |
| | | this RS |
| } | | |
| } | | |
| TLV information | Variable | |
| } | | |

Referring to Table 1, the NBR-ADV message includes the message type of the transmitted message, the number of neighbor BSs included, the identifier (ID) of each neighbor BS, the preamble index of the neighbor BS, information necessary for synchronization with the neighbor BS, the number of neighbor RSs managed by the neighbor BS, the ID of each neighbor RS, the preamble index of the neighbor RS, information necessary for synchronization with the neighbor RS, and type/length/value (TLV) information that can be temporarily included for the neighbor BS and the neighbor RS. The neighbor RS information included in the NBR-ADV message is about RSs managed by both the neighbor BSs and the serving BS. The neighbor BSs may include the serving BS.

The serving RS 340 and the direct-mode MSS 360 receive the NBR-ADV message from the serving BS 350 in steps 321 and 323, respectively, thereby acquiring the neighbor BS and RS information. The serving RS 340 or the direct-mode MSS 360 may hand over to one of the neighbor BSs or the neighbor RSs based on the neighbor BS and RS information.

In step 325, the serving RS 340 broadcasts the NBR-ADV message to the relay-mode MSS 310 managed by the serving RS 340. The NBR-ADV message may be sent using a particular connection ID (CID) so that it reaches only within the coverage area of the serving RS 340.

The relay-mode MSS 310 thus acquires the neighbor BS and RS information from the NBR-ADV message received from the serving RS 340 in step 327. The relay-mode MSS 310 can handover to a neighbor BS or a neighbor RS based on the neighbor BS and RS information.

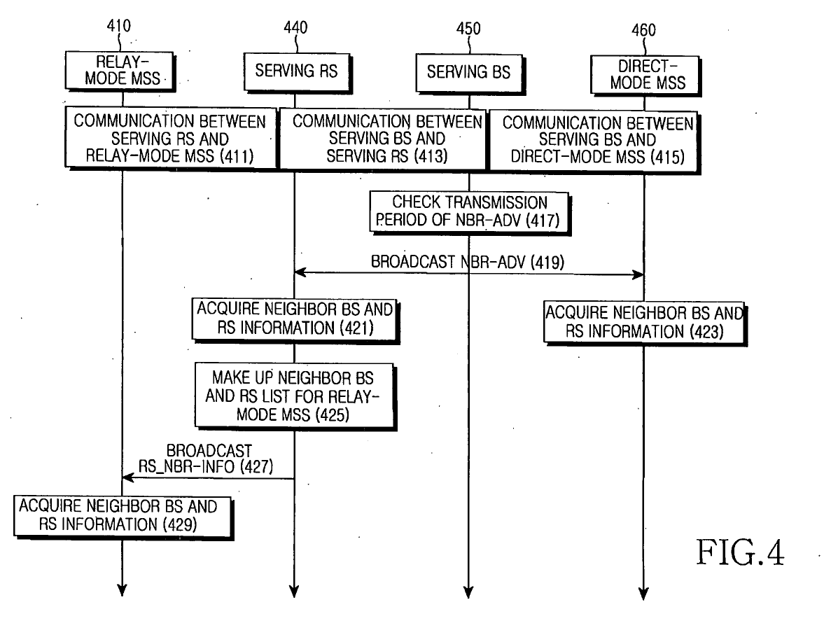

FIG. 4 is a diagram illustrating a signal flow for sending information about neighbor BSs and neighbor RSs configured by the serving BS in the multi-hop relay BWA communication system according to a second embodiment of the present invention.

Referring to FIG. 4, a relay-mode MSS 410 communicates with a serving RS 440 in step 411 and the serving RS 440 communicates with a serving BS 450 in step 413. A direct-mode MSS 460 communicates directly with the serving BS 450 in step 415.

In step 417, the serving BS 450 collects information about neighbor BSs and neighbor RSs, and checks the transmission period of an NBR-ADV message containing the neighbor BS except the serving BS itself and RS information, formatted as illustrated in Table 1. The serving BS 450 then broadcasts the NBR-ADV message to the serving RS 440 and the direct-mode MSS 460 in step 419.

The serving RS 440 and the direct-mode MSS 460 receive the NBR-ADV message from the serving BS 450 in steps 421 and 423, respectively, thereby acquiring the neighbor BS and RS information. The serving RS 440 or the direct-mode MSS 460 may hand over to a neighbor BS or a neighbor RS based on the neighbor BS and RS information.

In step 425, the serving RS 440 creates a list of neighbor BSs and neighbor RSs for which information is required for the relay-mode MSS 410 managed by the serving RS 440. The serving RS 440 broadcasts a neighbor BS/RS information (RS_NBR-INFO) message including the neighbor BS and RS list in step 427. The RS_NBR-INFO message has the configuration illustrated below in Table 2. The RS_NBR-INFO message may be sent using a particular CID so that it reaches only within the coverage area of the serving RS 440.

TABLE 2

| Syntax | Size (bits) | Notes |
|---|---|---|
| RS_NBR-INFO_format( ){ | | |
| Management Message Type | 8 | To be determined |
| =TBD | | |
| N_BS | 8 | Number of BSs; the serving BS may be |
| | | included |
| for(i=0;i<N_BS;i++){ | | |
| BS ID | 48 | BS Identifier |
| BS preamble index | 8 | — |
| BS synchronization | variable | The BS information that is necessary for MSS |
| information | | or RS to acquire synchronization with this BS |
| N_RS | 8 | Number of relay stations |
| for(j=0;j<N_RS;j++){ | | |
| RS ID | 48 | RS Identifier |
| RS preamble index | 8 | — |
| RS synchronization | variable | The RS information that is necessary for MSS |
| information | | or other RS to acquire synchronization with |
| | | this RS |
| } | | |
| } | | |
| TLV information | Variable | |
| } | | |

Referring to Table 2, the RS_NBR-INFO message includes the message type of the transmitted message, the number of neighbor BSs included, the ID of each neighbor BS, the preamble index of the neighbor BS, information necessary for synchronization with the neighbor BS, the number of neighbor RSs managed by the neighbor BS, the ID of each neighbor RS, the preamble index of the neighbor RS, information necessary for synchronization with the neighbor RS, and TLV information that can be temporarily included for the neighbor BS and the neighbor RS. The neighbor RS information included in the RS_NBR-INFO message is about RSs managed by the neighbor BSs and the serving BS. The neighbor BSs may include the serving BS.

As the relay-mode MSS 410 receives the RS_NBR-INFO message in step 429, it acquires the neighbor BS and RS information. The relay-mode MSS 410 can handover to a neighbor BS or a neighbor RS based on the neighbor BS and RS information.

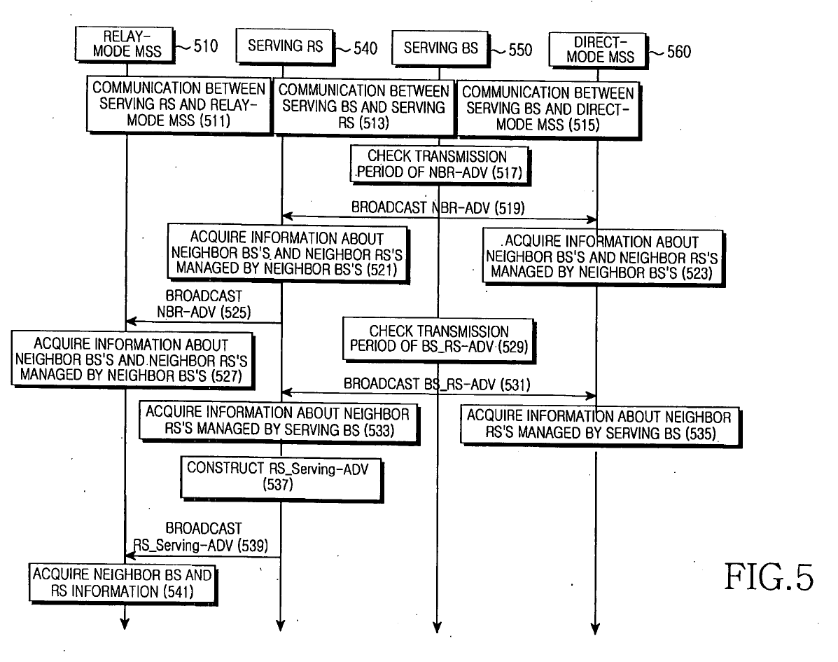

FIG. 5 is a diagram illustrating a signal flow for sending information about neighbor BSs and neighbor RSs configured by the serving BS in the multi-hop relay BWA communication system according to a third embodiment of the present invention. The serving BS provides information about neighbor RSs within a serving cell and information about neighbor RSs within neighbor cells by separate messages.

Referring to FIG. 5, a relay-mode MSS 510 communicates with a serving RS 540 in step 511 and the serving RS 540 communicates with a serving BS 550 in step 513. A direct-mode MSS 560 communicates directly with the serving BS 550 in step 515.

In step 517, the serving BS 550 collects information about neighbor BSs and neighbor RSs managed by the neighbor BSs, and checks the transmission period of a modified NBR-ADV message including the neighbor BS and RS information.

The serving BS 550 then broadcasts the modified NBR-ADV message to the serving RS 540 and the direct-mode MSS 560 in step 519.

The modified NBR-ADV message is configured as illustrated below in Table 3.

TABLE 3

| Syntax | Size (bits) | Notes |
|---|---|---|
| NBR-ADV_format( ){ | | |
| Management Message Type | 8 | To be determined |
| =TBD | | |
| N_BS | 8 | Number of neighbor BSs |
| for(i=0;i<N_BS;i++){ | | |
| BS ID | 48 | BS Identifier |
| BS preamble index | 8 | — |
| BS synchronization | variable | The BS information that is necessary for MSS |
| information | | or RS to acquire synchronization with this BS |
| N_RS | 8 | Number of relay stations |
| for(j=0;j<N_RS;j++){ | | |
| RS ID | 48 | RS Identifier |
| RS preamble index | 8 | — |
| RS synchronization | variable | The RS information that is necessary for MSS |
| information | | or other RS to acquire synchronization with |
| | | this RS |
| } | | |
| } | | |
| TLV information | Variable | |
| } | | |

Referring to Table 3, the modified NBR-ADV message includes the message type of the transmitted message, the number of neighbor BSs included, the ID of each neighbor BS, the preamble index of the neighbor BS, information necessary for synchronization with the neighbor BS, the number of neighbor RSs managed by the neighbor BS, the ID of each neighbor RS, the preamble index of the neighbor RS, information necessary for synchronization with the neighbor RS, and TLV information that can be temporarily included for the neighbor BS and the neighbor RS. The neighbor RS information included in the NBR-ADV message is about RSs managed by the neighbor BSs.

The serving RS 540 and the direct-mode MSS 560 receive the modified NBR-ADV message from the serving BS 550 in steps 521 and 523, respectively, thereby acquiring the information about the neighbor BSs and the neighbor RSs managed by the neighbor BSs. The serving RS 540 or the direct-mode MSS 560 may hand over to one of the neighbor BSs or the neighbor RSs based on the neighbor BS and RS information.

In step 525, the serving RS 540 broadcasts the modified NBR-ADV message to the relay-mode MSS 510 managed by the serving RS 540. The NBR-ADV message may be sent using a particular CID so that it reaches only within the coverage area of the serving RS 540.

As the relay-mode MSS 510 receives the modified NBR-ADV message in step 527, it acquires the information about the neighbor BSs and the neighbor RSs managed by the neighbor BSs. The relay-mode MSS 510 can handover to one of the neighbor BSs or the neighbor RSs based on the neighbor BS and RS information.

In step 529, the serving BS 550 configures a serving cell relay station advertisement (BS_RS-ADV) including information about its managed RSs on a periodic basis and checks the transmission period of the BS_RS-ADV message. The serving BS 550 then broadcasts the BS_RS-ADV message to the serving BS 540 and the direct-mode MSS 560 in step 531.

The BS_RS-ADV message has the configuration illustrated below in Table 4.

TABLE 4

| Syntax | Size (bits) | Notes |
|---|---|---|
| BS_RS-ADV_format( ){ | | |
| Management Message Type | 8 | To be determined |
| =TBD | | |
| N_RS | 8 | Number of relay |
| | | stations in serving cell |
| for(j=0;j<N_RS;j++){ | | |
| RS ID | 48 | RS Identifier |
| RS preamble index | 8 | — |
| RS synchronization | variable | The RS information that is |
| information | | necessary for MSS or other |
| | | RS to acquire synchronization |
| | | with this RS |
| } | | |
| TLV information | Variable | |
| } | | |

Referring to Table 4, the BS_RS-ADV message includes the message type of the transmitted message, the number of neighbor RSs included, the ID of each neighbor RS, the preamble index of the neighbor RS, information necessary for synchronization with the neighbor RS, and TLV information that can be temporarily included for the neighbor RS. The neighbor RSs listed in the BS_RS-ADV message are those managed by the serving BS.

The serving RS 540 and the direct-mode MSS 560 receive the BS_RS-ADV message from the serving BS 550 in steps 533 and 535, respectively, thereby acquiring the information about the neighbor RSs managed by the serving BS 550. The serving RS 540 or the direct-mode MSS 560 may hand over to one of the neighbor RSs based on the neighbor RS information.

In step 537, the serving RS 540 configures an RS_Serving-ADV message including information about the serving BS 550 and the neighbor RSs within the serving cell.

The RS_Serving-ADV message has the configuration illustrated below in Table 5.

TABLE 5

| Syntax | Size (bits) | Notes |
|---|---|---|
| RS_Serving-ADV_format( ){ | | |
| Management Message Type | 8 | To be determined |
| =TBD | | |
| BS ID | 48 | Serving BS Identifier |
| BS preamble index | 8 | — |
| BS synchronization | variable | The BS information that is necessary for MSS |
| information | | or RS to acquire synchronization with this BS |
| N_RS | 8 | Number of relay stations in serving cell |
| for(j=0;j<N_RS;j++){ | | |
| RS ID | 48 | RS Identifier |
| RS preamble index | 8 | — |
| RS synchronization | variable | The RS information that is necessary for MSS |
| information | | or other RS to acquire synchronization with |
| | | this RS |
| } | | |
| TLV information | Variable | |
| } | | |

Referring to Table 5, the RS_Serving-ADV message includes the message type of the transmitted message, the ID of the serving BS, the preamble index of the serving BS, information necessary for synchronization with the serving BS, the number of neighbor RSs managed by the serving BS, the ID of each neighbor RS, the preamble index of the neighbor RS, information necessary for synchronization with the neighbor RS, and TLV information that can be temporarily included for the serving BS and the neighbor RS.

The serving RS 540 broadcasts the RS_Serving-ADV message to the relay-mode MSS 510 in step 539. The RS_Serving-ADV message may be sent using a particular CID so that it reaches only within the coverage area of the serving RS 540.

As the relay-mode MSS 510 receives the RS_Serving-ADV message in step 541, it acquires the information about the serving BS 550 and the neighbor RSs managed by the serving BS 550. The relay-mode MSS 510 can handover to the serving BS 550 or a neighbor RS managed by the serving BS 550 based on the neighbor RS information.

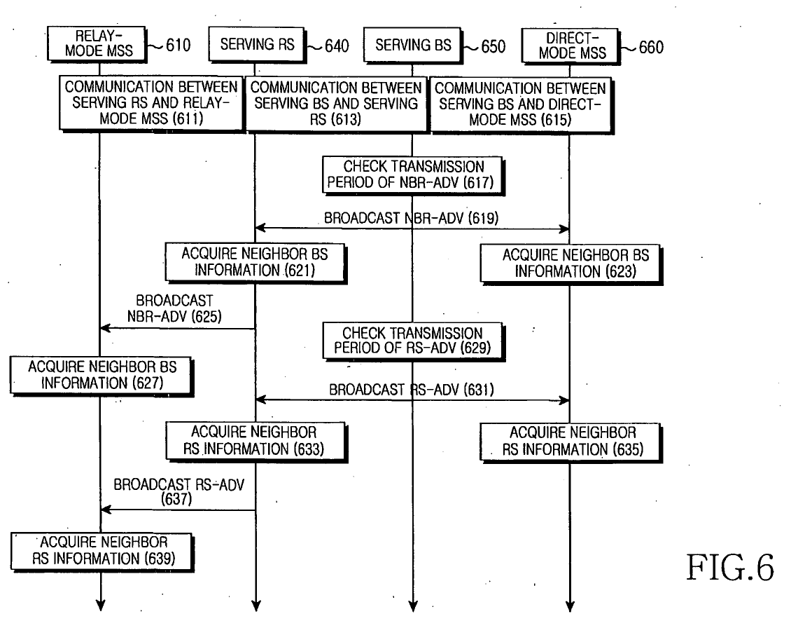

FIG. 6 is a diagram illustrating a signal flow for sending information about neighbor BSs and neighbor RSs configured by the serving BS in the multi-hop relay BWA communication system according to a fourth embodiment of the present invention. The serving BS provides information about neighbor BSs and neighbor RSs by separate messages.

Referring to FIG. 6, a relay-mode MSS 610 communicates with a serving RS 640 in step 611 and the serving RS 640 communicates with a serving BS 650 in step 613. A direct-mode MSS 660 communicates directly with the serving BS 650 in step 615.

In step 617, the serving BS 650 collects information about neighbor BSs and checks the transmission period of a modified NBR-ADV message including the neighbor BS information. The serving BS 650 then broadcasts the modified NBR-ADV message to the serving RS 640 and the direct-mode MSS 660 in step 619.

The modified NBR-ADV message is configured as illustrated below in Table 6.

TABLE 6

| Syntax | Size (bits) | Notes |
|---|---|---|
| NBR-ADV_format( ){ | | |
| Management Message Type | 8 | To be determined |
| =TBD | | |
| N_BS | 8 | Number of neighbor BSs |
| for(i=0;i<N_BS;i++){ | | |
| BS ID | 48 | BS Identifier |
| BS preamble index | 8 | — |
| BS synchronization | variable | The BS information that is |
| information | | necessary for MSS or RS to |
| | | acquire synchronization with |
| | | this BS |
| } | | |
| TLV information | Variable | |
| } | | |

Referring to Table 6, the modified NBR-ADV message includes the message type of the transmitted message, the number of neighbor BSs included, the ID of each neighbor BS, the preamble index of the neighbor BS, information necessary for synchronization with the neighbor BS, and TLV information that can be temporarily included for the neighbor BS.

The serving RS 640 and the direct-mode MSS 660 receive the modified NBR-ADV message from the serving BS 650 in steps 621 and 623, respectively, thereby acquiring the neighbor BS information. The serving RS 640 or the direct-mode MSS 660 may hand over to a neighbor BS based on the neighbor BS information.

In step 625, the serving RS 640 broadcasts the modified NBR-ADV message to the relay-mode MSS 610 managed by the serving RS 640. The NBR-ADV message includes the information of the serving BS 650. The NBR-ADV message may be sent using a particular CID so that it reaches only within the coverage area of the serving RS 640.

As the relay-mode MSS 610 receives the modified NBR-ADV message in step 627, it acquires the neighbor BS information. The relay-mode MSS 610 can hand over to one of the neighbor BSs based on the neighbor BS information.

In step 629, the serving BS 650 configures a relay station advertisement (RS-ADV) message including information about RSs managed by the serving BS 650 and the neighbor BSs on a periodic basis and checks the transmission period of the RS-ADV message. The serving BS 650 then broadcasts the RS-ADV message to the serving RS 640 and the direct-mode MSS 660 in step 631.

The RS-ADV message has the configuration illustrated below in Table 7.

TABLE 7

| Syntax | Size (bits) | Notes |
|---|---|---|
| RS-ADV_format( ){ | | |
| Management Message Type | 8 | To be determined |
| =TBD | | |
| N_BS | 8 | Number of neighbor BSs; |
| | | including serving BS |
| for(i=0;i<N_BS;i++){ | | |
| BS ID | 48 | BS Identifier |
| N_RS | 8 | Number of relay stations |
| for(j=0;j<N_RS;j++){ | | |
| RS ID | 48 | RS Identifier |
| RS preamble index | 8 | — |
| RS synchronization | variable | The RS information that is |
| information | | necessary for MSS or other |
| | | RS to acquire |
| | | synchronization with this |
| | | RS |
| } | | |
| } | | |
| TLV information | Variable | |
| } | | |

Referring to Table 7, the RS-ADV message includes the message type of the transmitted message, the number of neighbor BSs included, the ID of each neighbor BS, the number of neighbor RSs managed by the neighbor BS, the ID of each neighbor RS, the preamble index of the neighbor RS, information necessary for synchronization with the neighbor RS, and TLV information that can be temporarily included for the neighbor RS. The serving BS and the neighbor RS list managed by the serving BS are included.

The serving RS 640 and the direct-mode MSS 660 receive the RS-ADV message from the serving BS 650 in steps 633 and 635, respectively, thereby acquiring the information about the neighbor RSs managed by the serving BS 650 and the neighbor BSs. The serving RS 640 or the direct-mode MSS 660 may hand over to a neighbor RS based on the neighbor RS information.

In step 637, the serving RS 640 broadcasts the RS-ADV message to the relay-mode MSS 610. The RS-ADV message may be sent using a particular CID so that it reaches only within the coverage area of the serving RS 640.

As the relay-mode MSS 610 receives the RS-ADV message in step 639, it acquires the information about the neighbor RSs managed by the serving BS 550 and the neighbor BSs. The relay-mode MSS 610 can handover to a neighbor RS based on the neighbor RS information.

Methods of providing information about neighbor BSs and neighbor RSs to a direct-mode MSS and an RS which communicate directly with a BS and to a relay-mode MSS which cannot communicate directly with the BS in a multi-hop relay BWA communication system have been described above. The following description applies to a system for providing the neighbor BS and RS information in conjunction with the block diagrams of the BS, the RS, and the MSS in the multi-hop relay BWA communication system.

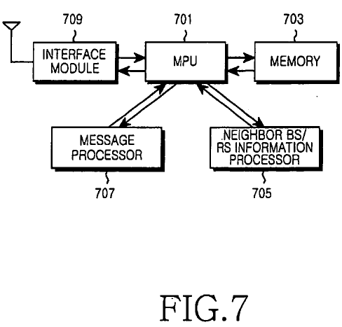

FIG. 7 is a block diagram of the MSS in the multi-hop relay BWA communication system according to the present invention.

Referring to FIG. 7, the MSS includes a Micro-Processor Unit (MPU) 701, a memory 703, a neighbor BS/RS information processor 705, a message processor 707 and an interface module 709.

In operation, the MPU 701 controls the operation of the MSS. For example, the MPU 701 processes and controls voice and data communication. In addition to the typical functionality, the MPU 701 processes neighbor BS or neighbor RS information received from the BS or the RS by controlling the message processor 707 and the neighbor BS/RS information processor 705. A description of the conventional processing and control operation of the MPU 701 is not provided herein for the sake of conciseness.

The memory 703 stores the micro-codes of programs for processing and controlling in the MPU 701, reference data, temporary data generated during execution of the programs and updatable data. In addition, the memory 703 includes a data buffer for storing data and control information to be sent to the BS or the RS. Additionally, the memory 703 stores the neighbor BS or neighbor RS information received from the BS or the RS.

The neighbor BS/RS information processor 705 recognizes the information about neighbor BSs and neighbor RSs received from the BS or the RS and operates according to the information.

The message processor 707 processes messages received from an antenna through the interface module 709 and the MPU 701, such as the NBR-ADV message illustrated in Table 1, the RS_NBR-INFO message illustrated in Table 2, the NBR-ADV message illustrated in Table 3, the BS_RS-ADV message llustrated in Table 4, the RS_Serving-ADV message illustrated in Table 5, the NBR-ADV message illustrated in Table 6, and the RS-ADV message illustrated in Table 7.

The interface module 709 processes messages and data transmitted and received between the MSS and the BS or between the MSS and the RS, and radio processes the data. Specifically, the interface module 709 upconverts a message or data to be transmitted to a frequency band, processes the upconverted message or data in a transmission scheme, and transmits the processed message or data. The interface module 709 also processes a received message or data in the reverse order of the transmission operation and downconverts the received message or data.

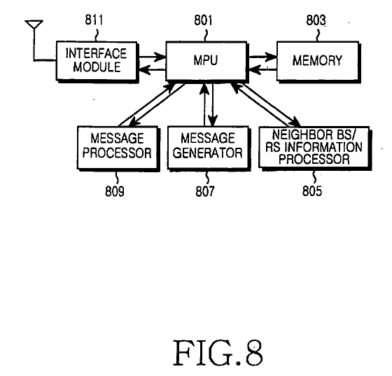

FIG. 8 is a block diagram of the RS for processing neighbor BS and neighbor RS information in the multi-hop relay BWA communication system according to the present invention.

Referring to FIG. 8, the RS includes an MPU 801, a memory 803, a neighbor BS/RS information processor 805, a message generator 807, a message processor 809 and an interface module 811.

In operation, the MPU 801 provides overall control to the operation of the RS. The MPU 801 controls the message processor 809, the message generator 807, and the neighbor BS/RS information processor 805, configures neighbor BS and RS information to be sent to the relay-mode MSS based on neighbor BS and RS information received from the BS, and transmits the configured neighbor BS and RS information to the relay-mode MSS.

The memory 803 includes a data buffer for storing data and control information to be transmitted to the relay-mode MSS and the BS. The memory 803 stores the neighbor BS and RS information received from the BS.

The neighbor BS/RS information processor 805 recognizes the information about neighbor BSs and neighbor RSs received from the BS and operates according to the information. The neighbor BS/RS information processor 805 also configures neighbor BS and RS information to be transmitted to the relay-mode MSS and performs an operation required for sending the configured neighbor BS and RS information to the relay-mode MSS.

The message generator 807 generates a message to be transmitted to the MSS, such as the NBR-ADV message illustrated in Table 1, the RS_NBR-INFO message illustrated in Table 2, the NBR-ADV message illustrated in Table 3, the RS_Serving-ADV message illustrated in Table 5, the NBR-ADV message illustrated in Table 6, and the RS-ADV message illustrated in Table 7. The message is broadcast to the MSS through the MPU 801 and the interface module 811. The broadcast transmission may be limited to MSSs managed by the RS.

The message processor 809 processes a message received through the interface module 811 and the MPU 801, such as the NBR-ADV message illustrated in Table 1, the NBR-ADV message illustrated in Table 3, the BS_RS-ADV message illustrated in Table 4, the NBR-ADV message illustrated in Table 6, and the RS-ADV message illustrated in Table 7.

The interface module 811 processes messages and data transmitted and received between the RS and the BS or between the RS and the relay-mode MSS, and radio processes the data. Specifically, the interface module 811 upconverts a message or data to be transmitted to a frequency band, processes the upconverted message or data in a transmission scheme, and transmits the processed message or data. The interface module 811 also processes a received message or data in the reverse order of the transmission operation and downconverts the received message or data.

In the present invention, in an OFDM/OFDMA BWA communication system, particularly a multi-hop relay BWA communication system including an RS which can provide a multi-hop relay path between a BS and an MSS when a direct link channel between the BS and the MSS is in a poor channel state, the BS sends a message including information about neighbor RSs and neighbor BSs to the RS, relay-mode MSSs and direct-mode MSSs so that the RS, the relay-mode MSSs, and the direct-mode MSSs can hand over to the neighbor BSs or the neighbor RSs based on the neighbor BS and RS information.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of acquiring information about neighbor base stations (BSs) and neighbor relay stations (RSs) in a multi-hop relay communication system, comprising the steps of:
collecting, by a serving BS, information about the neighbor BSs and the neighbor RSs, generating, by the serving BS, a message including the collected information, and transmitting, by the serving BS, the message to a serving RS and a mobile subscriber station (MSS) directly communicating with the serving BS; and
transmitting, by a serving RS, the message to an MSS communicating with the serving BS via the serving RS.

2. The method of claim 1, further comprising determining, by the serving BS, a transmission period of the message.

3. The method of claim 1, wherein each of the message transmission steps further comprises broadcasting the message.

4. The method of claim 1, wherein the neighbor BSs include the serving BS.

5. The method of claim 1, wherein the neighbor RSs include RSs managed by the serving BS and RSs managed by the neighbor BSs.

6. A method of acquiring information about neighbor base stations (BSs) and neighbor relay stations (RSs) in a multi-hop relay communication system, comprising the steps of:
collecting, by a serving BS, information about the neighbor BSs and the neighbor RSs, and generating, by the serving BS, a first message including information about the neighbor BSs and neighbor RSs managed by the neighbor BSs, and a second message including information about neighbor RSs managed by a serving BS; and
determining, by the serving BS, transmission periods of the first and second messages and transmitting the first and second messages to a serving RS and a mobile subscriber station (MSS) directly communicating with the serving BS in the transmission periods.

7. The method of claim 6, further comprising:
transmitting, by the serving RS, the first message to an MSS communicating with the serving BS via the serving RS; and
generating by the serving RS a third message by adding information about the serving BS to the second message and transmitting by the serving RS the third message to the MSS communicating with the serving BS via the serving RS.

8. The method of claim 6, wherein the transmission step further comprises broadcasting the first and second messages.

9. A method of acquiring information about neighbor base stations (BSs) and neighbor relay stations (RSs) in a multi-hop relay communication system, comprising the steps of:
collecting information about the neighbor BSs and the neighbor RSs;
generating, by a serving BS, a first message including information about the neighbor BSs and a second message including information about the neighbor RSs;
determining, by the serving BS, transmission periods of the first and second messages and transmitting the first and second messages to a serving RS and a mobile subscriber station (MSS) directly communicating with the serving BS in the transmission periods; and
transmitting, by the serving RS, the first and second messages to an MSS communicating with the serving BS via the serving RS.

10. The method of claim 9, wherein each of the message transmission steps further comprises broadcasting the first and second messages.

11. The method of claim 9, wherein the neighbor BSs include the serving BS.

12. The method of claim 9, wherein the neighbor RSs include RSs managed by the serving BS and RSs managed by the neighbor BSs.

13. A system for acquiring information about neighbor base stations (BSs) and neighbor relay stations (RSs) in a multi-hop relay communication system, comprising:
a serving BS for collecting information about the neighbor BSs and the neighbor RSs, generating a first message including the collected information, and transmitting the first message to a serving RS and a mobile subscriber station (MSS) directly communicating with a serving BS; and
the serving RS for acquiring the information about the neighbor BSs and the neighbor RSs, creating a list of neighbor BSs and neighbor RSs required for an MSS communicating with the serving BS via the serving RS, generating a second message including the list, and transmitting the second message to the MSS communicating with the serving BS via the serving RS.

14. The system of claim 13, wherein the serving BS broadcasts the first message and the serving RS broadcasts the second message.

15. The system of claim 14, wherein the neighbor BSs include the serving BS.

16. The system of claim 13, wherein the neighbor RSs include RSs managed by the serving BS and RSs managed by the neighbor BSs.

17. A system for providing information about neighbor base stations (BSs) and neighbor relay stations (RSs) in a multi-hop relay communication system, comprising:
a serving BS for collecting information about the neighbor BSs and the neighbor RSs, generating a first message including information about neighbor BSs and neighbor RSs managed by the neighbor BSs and a second message including information about neighbor RSs managed by the serving BS, determining transmission periods of the first and second messages, and transmitting the first and second messages to a serving RS and a mobile subscriber station (MSS) directly communicating with the serving BS in the transmission periods; and
the serving RS for, upon receipt of the first message, transmitting the first message to an MSS communicating with the serving BS via the serving RS, and upon receipt of the second message, generating a third message including information about the serving BS and the neighbor RSs managed by the serving BS, and transmitting the third message to the MSS communicating with the serving BS via the serving RS.

18. The system of claim 17, wherein the serving BS broadcasts the first and second messages and the serving RS broadcasts the first and third messages.

19. A system for providing information about neighbor base stations (BSs) and neighbor relay stations (RSs) in a multi-hop relay communication system, comprising:
a serving BS for collecting information about the neighbor BSs and the neighbor RSs, generating a first message including information about the neighbor BSs and a second message including information about the neighbor RSs, determining transmission periods of the first and second messages, and transmitting the first and second messages to a serving RS and a mobile subscriber station (MSS) directly communicating with the serving BS in the transmission periods; and
the serving RS for, upon receipt of the first and second messages, transmitting the first and second messages to an MSS communicating with the serving BS via the serving RS.

20. The system of claim 19, wherein the serving BS and the serving RS broadcast the first and second messages.

21. The system of claim 19, wherein the neighbor BSs include the serving BS.

22. The system of claim 19, wherein the neighbor RSs include RSs managed by the serving BS and RSs managed by the neighbor BSs.

23. A method of acquiring information about neighbor base stations (BSs) and neighbor relay stations (RSs) in a multi-hop relay communication system, comprising the steps of:
collecting, by a serving BS, information about the neighbor BSs and the neighbor RSs, generating, by the serving BS, a first message including the collected information, and transmitting, by the serving BS, the first message to a serving RS and a mobile subscriber station (MSS) directly communicating with a serving BS; and
creating, by the serving RS, a list of neighbor BSs and neighbor RSs required for an MSS communicating with the serving BS via the serving RS, generating by the serving RS a second message including the list, and transmitting by the serving RS the second message to the MSS communicating with the serving BS via the serving RS.

24. The method of claim 23, further comprising determining, by the serving BS, a transmission period of the first message.

25. The method of claim 23, wherein each of the message transmission steps further comprises broadcasting the message.

26. The method of claim 23, wherein the neighbor BSs include the serving BS.

27. The method of claim 23, wherein the neighbor RSs include RSs managed by the serving BS and RSs managed by the neighbor BSs.

28. A system for providing information about neighbor base stations (BSs) and neighbor relay stations (RSs) in a multi-hop relay communication system, comprising:
a serving BS for collecting information about the neighbor BSs and the neighbor RSs, generating a message including the collected information, determining a transmission period of the message, and transmitting the message to a serving RS and a mobile subscriber station (MSS) directly communicating with the serving BS in the transmission period; and
the serving RS for, upon receipt of the message, transmitting the message to an MSS communicating with the serving BS via the serving RS.

29. The system of claim 28, wherein the serving BS and the serving RS broadcast the message.

30. The system of claim 28, wherein the neighbor BSs include the serving BS.

31. The system of claim 28, wherein the neighbor RSs include RSs managed by the serving BS and RSs managed by the neighbor BSs.
